(19) United States
(12) Patent Application Publication
(10) Pub. No.: US 2026/0239306 A1
(43) Pub. Date: Aug. 13, 2026

(54) SYSTEM AND METHOD FOR APPLICATION SPECIFIC SCHEDULING IN OPEN RADIO ACCESS NETWORK

(71) Applicant: JIO PLATFORMS LIMITED, Ahmedabad (IN)

(72) Inventors: Pradeep HIRISAVE, Bengaluru (IN); Satish JAMADAGNI, Bangalore (IN); Vinay Kumar SHRIVASTAVA, Bangalore (IN); Mathew OOMMEN, Plano, TX (US)

(73) Assignee: JIO PLATFORMS LIMITED, Ahmedabad (IN)

(21) Appl. No.: 19/150,637

(22) PCT Filed: Jan. 27, 2024
(86) PCT No.: PCT/IB2024/050772

§ 371 Date: Jul. 24, 2025

(30) Foreign Application Priority Data
Jan. 27, 2023 (IN) 202321005591

(51) Int. Cl. H04W 72/0446; H04W 56/00; H04W 72/1263; H04W 72/23

(52) U.S. Cl. CPC H04W 72/0446; H04W 56/0005; H04W 72/1263; H04W 72/23

(57) ABSTRACT

The present disclosure provides a system (134) and a method for application specific scheduling in an Open Radio Access Network (ORAN). The system (134) receives data timing information associated with one or more user equipments (UEs) (108) coupled to the ORAN via a Lightweight Application Function (LAF) (102). The LAF (102) is configured to receive the data timing information from an AF (110) configured in a core network (114). The system (134) determines if uplink synchronization is established between the ORAN (104) and the one or more UEs (108), and in response to a positive determination, transmits scheduling information to the one or more UEs (108) from the ORAN (104). The system (134) allocates one or more resource blocks (RBs) to the one or more UEs (108) and enables data transfer between the ORAN (104) and the one or more UEs (108).

### RESERVATION OF RIGHTS

A portion of the disclosure of this patent document contains material, which is subject to intellectual property rights such as but are not limited to, copyright, design, trademark, integrated circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The embodiments of the present disclosure generally relate to systems and methods for scheduling in a wireless network. More particularly, the present disclosure relates to a system and a method for application specific scheduling in an Open Radio Access Network (ORAN).

### BACKGROUND

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

Fifth Generation (5G) wireless technology that was developed as a part of the Third Generation Partnership Project (3GPP) is meant to deliver higher multi-Giga bytes per second (Gbps) peak data speeds, ultra-low latency, more reliability, massive network capacity, increased availability, and a more uniform user experience to more users. Sixth Generation (6G) network provides novel radio and access architecture for both communication and sensing purposes, Artificial Intelligence (AI) optimized wide area network and data center co-design, as well as dynamic orchestration of personalized services to revolutionize the long tail of niche consumer interests. While demand for mobile broadband will continue to increase for consumers and enterprise alike, uptake of ultra-reliable and low latency will be largely driven by specialized and local use cases in conjunction with non-public network, and often with augmented intelligence. One of the key requirements for 6G cellular network radio base stations which is expected to support mobility access nodes such as access nodes on Uncrewed/Unmanned Aerial Vehicles (UAVs) is the coreless network concept, i.e., Radio Access Network (RAN) node will have to work independent of a core network. To support such independent RAN that can work independent of the core network, various architectures are proposed that authenticate and authorize user equipments (UEs).

However, allocation of resources in the 5G and 6G networks may increase the overhead among the uplink and downlink control channels. There is, therefore, a need in the art to provide a system and a method that can mitigate the problems associated with the allocation of resources in 5G and 6G Open Radio Access Network (ORAN).

### OBJECTS OF THE INVENTION

Some of the objects of the present disclosure, which at least one embodiment herein satisfies are listed herein below.

It is an object of the present disclosure to provide a system and a method for application specific scheduling in an Open Radio Access Network (ORAN) that improves the spectral efficiency by reducing an overhead on radio resources used by control channel information in an uplink (UL) and a downlink (DL) direction.

It is an object of the present disclosure to introduce a new optimized mechanism to share control information in either the UL or in the DL direction, thereby reducing the overhead on control channels.

It is an object of the present disclosure to provide a system and a method for application specific scheduling in the ORAN, where a Lightweight Application Server (LAS) is coupled with a Radio Access Network (RAN) node for receiving data timing information associated with User Equipments (UEs) from another AS in a core network.

It is an object of the present disclosure where the ORAN receives the data timing information from the LAS and provides scheduling information to the UEs with a specific periodicity.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure relates to a system for application specific scheduling in an Open Radio Access Network (ORAN). The system includes a processor communicatively coupled to the ORAN and a memory operatively coupled with the processor. The memory stores instructions which, when executed by the processor, causes the processor to receive data timing information associated with one or more user equipments (UEs) coupled to the ORAN via a Lightweight Application Function (LAF). The LAF is communicatively coupled to the ORAN and configured to receive the data timing information from an AF configured in a core network. The processor determines if uplink synchronization is established between the ORAN and the one or more UEs based on the data timing information. The processor, in response to a positive determination, transmits scheduling information to the one or more UEs from the ORAN, where the scheduling information includes a periodicity associated with allocation of one or more resource blocks (RBs). The processor allocates the one or more RBs to the one or more UEs based on the scheduling information. The processor enables data transfer between the ORAN and the one or more UEs based on the allocated one or more RBs.

In an embodiment, in response to a negative determination, the processor may restrict the transmission of the scheduling information to the one or more UEs.

In an embodiment, in response to the positive determination, the processor may determine, via a machine learning model, a data transmission pattern form the data timing information for a predetermined period, and transmit the scheduling information to the one or more UEs based on the data transmission pattern.

In an embodiment, the one or more UEs may be configured to transmit the data timing information to the AF via an Internet Protocol (IP).

In an aspect, the present disclosure relates to a method for application specific scheduling in an ORAN. The method includes receiving, by a processor associated with a system, data timing information associated with one or more UEs coupled to the ORAN via a LAF. The LAF is configured to receive the data timing information from an AF configured in a core network. The method includes determining, by the processor, if uplink synchronization is established between the ORAN and the one or more UEs based on the data timing information. The method includes, in response to a positive determination, transmitting, by the processor, scheduling information to the one or more UEs from the ORAN, where the scheduling information includes a periodicity associated with allocation of one or more RBs. The method includes allocating, by the processor, the one or more RBs to the one or more UEs based on the scheduling information. The method includes enabling, by the processor, data transfer between the ORAN and the one or more UEs based on the allocated one or more RBs.

In an embodiment, in response to a negative determination, the method may include restricting, by the processor, the transmission of the scheduling information to the one or more UEs.

In an embodiment, the method may include determining, by the processor, in response to the positive determination, via a machine learning model, a data transmission pattern from the data timing information for a predetermined period, and transmitting, by the processor, the scheduling information to the one or more UEs based on the data transmission pattern.

In an embodiment, the method may include transmitting, by the one or more UEs, the data timing information to the AF via an IP.

In an aspect, a UE for sending requests includes one or more processors communicatively coupled to a processor associated with a system and configured with an ORAN. The one or more processors are coupled with a memory, where said memory stores instructions which, when executed by the one or more processors, cause the one or more processors to transmit data timing information to an AF in a core network. The UE is configured to receive the data timing information from the AF configured in the core network. The processor is configured to receive the data timing information from the UE via a LAF, where the LAF is communicatively coupled to the ORAN. The processor determines if uplink synchronization is established between the ORAN and the UE based on the data timing information. The processor, in response to a positive determination, transmits scheduling information to the UE from the ORAN, where the scheduling information includes a periodicity associated with allocation of one or more RBs. The processor allocates the one or more RBs to the UE based on the scheduling information. The processor enables data transfer between the ORAN and the UE based on the allocated one or more RBs.

In an aspect, a non-transitory computer readable medium comprising a processor with executable instructions, cause the processor to receive data timing information associated with one or more UEs coupled to an ORAN via a LAF. The LAF is communicatively coupled to the ORAN and configured to receive the data timing information from an AF configured in a core network. The processor determines if uplink synchronization is established between the ORAN and the one or more UEs based on the data timing information. The processor, in response to a positive determination, transmits scheduling information to the one or more UEs from the ORAN, where the scheduling information includes a periodicity associated with allocation of the one or more RBs. The processor allocates the one or more RBs to the one or more UEs based on the scheduling information. The processor enables data transfer between the ORAN and the one or more UEs based on the allocated one or more RBs.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an example network architecture (100) for implementing a proposed system (134), in accordance with an embodiment of the present disclosure.

FIG. 2 illustrates an example block diagram (200) of a proposed system (134), in accordance with an embodiment of the present disclosure.

FIG. 3 illustrates an example representation (300) of a scheduling process in an Open Radio Access Network (ORAN), in accordance with an embodiment of the present disclosure.

FIG. 4 illustrates an example flow diagram (400) of the scheduling process, in accordance with an embodiment of the present disclosure.

FIGS. 5A-5D illustrate example flow diagrams (500A, 500B, 500C, 500D) of a scheduling process by the proposed system (134), in accordance with embodiments of the present disclosure.

FIG. 6 illustrates an example computer system (600) in which or with which embodiments of the present disclosure may be implemented.

The foregoing shall be more apparent from the following more detailed description of the disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive in a manner similar to the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Internet of Things (IoT) application data is timed and predictable in most cases specifically when the data is from sensors, cameras, etc., which render themselves to certain optimizations in terms of scheduling resources to such IoT devices. To avoid an overhead on the end-to-end system and especially in the Open Radio Access Network (ORAN), there are many optimizations that are possible and one such optimization is to extend a semi-persistent scheduling concept to the data generated by IoT devices. Further, in fifth Generation (5G)/sixth generation (6G) networks, one of the major entities of the end-to-end network architecture is an Application Function (AF)/Server (AS), and IoT device (or user equipment (UE)).

Most IoT applications are expected to send data at specific time periods, and therefore, the present disclosure introduces a mechanism to reduce control channel overheads specifically on downlink control channels and thereby increase the spectral efficiency of the ORAN. Such new mechanisms are proposed for both periodic/aperiodic, bursty traffic, and as well for the ORAN or network with a core. Further, the present disclosure introduces a mechanism to share timing related information to a UE for receiving the downlink (DL) data so that the UE wakes up at the right instance of time.

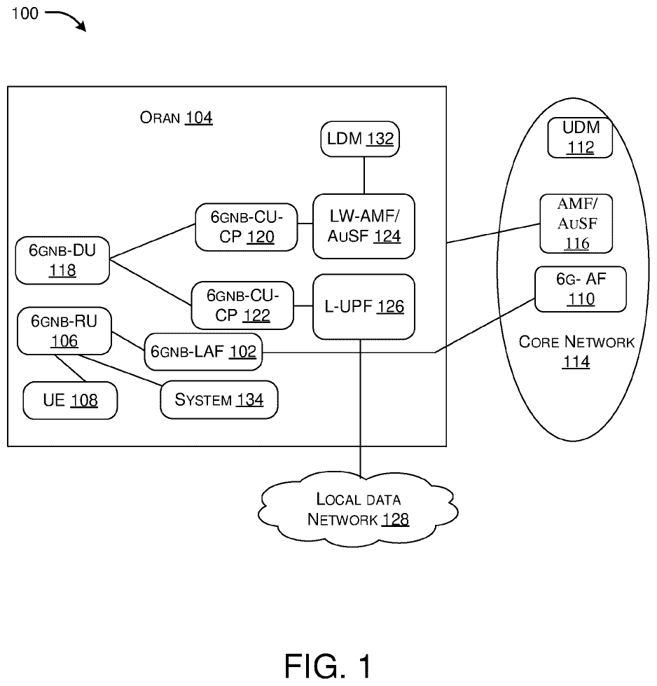

Various embodiments of the present disclosure will be explained in detail with reference to FIGS. 1-6.

FIG. 1 illustrates an example network architecture (100) for implementing a proposed system (134), in accordance with an embodiment of the present disclosure.

As illustrated in FIG. 1, the network architecture (100) may include a Lightweight Application Function (102) which may be connected to the ORAN/coreless network (104). The LAF (102) may be connected to a sixth generation g Node B (6gNB) Radio Unit (RU) (106) of the ORAN (104). The LAF (102) may be a proxy server that exists with the ORAN (104) and may include periodicity related information. This proxy server, via a predefined gateway, may be in synchronization with an AF (110) in a core network (114) and may dictate the RU (106) on scheduling information by sharing data timing information associated with one or more UEs (108) connected to the ORAN (104). The core network (114) may include a unified data management (UDM) module (112), an access and mobility management function/authentication server function (AMF/AUSF) (116), and the AF (110). Further, a 6gNB distributed unit (118) may be included in the ORAN (104). The 6gNB distributed unit (118) may be connected to 6gNB control units (120, 122) and may each be connected to the Lightweight AMF/AUSF (124) and a Lightweight user plane function (UPF) (126). The UPF (126) may be connected to a local data network (128) and a Lightweight AMF/AUSF (124) may be connected to a Lightweight Data Module (LDM) module (132) in the coreless network (104).

In an embodiment, the system (134) configured with the 6gNB Radio Unit (RU) (106) of the ORAN (104) may receive data timing information associated with one or more UEs (108) coupled to the ORAN (104) via the LAF (102), where the LAF (102) may be configured to receive the data timing information from the AF (110) configured in the core network (114). The system (134) may determine if uplink synchronization is established between the ORAN (104) and the one or more UEs (108) based on the data timing information. In response to a positive determination, the system (134) may transmit scheduling information to the one or more UEs (108) from the ORAN (104), where the scheduling information may include a periodicity associated with allocation of one or more Resource Blocks (RBs). In response to a negative determination, the system (134) may restrict the transmission of the scheduling information to the one or more UEs (108).

In an embodiment, the system (134) may allocate one or more RBs to the one or more UEs (108) based on the scheduling information. The system (134) may enable data transfer between the ORAN (104) and the one or more UEs (108) based on the allocation of the one or more RBs.

In another embodiment, the system (134) may, in response to the positive determination, determine, via a machine learning model, a data transmission pattern form the data timing information for a predetermined period and transmit the scheduling information to the one or more UEs (108) based on the data transmission pattern.

In another embodiment, the one or more UEs (108) may be configured to transmit the data timing information to the AF (110) via an Internet Protocol (IP).

Although FIG. 1 shows exemplary components of the network architecture (100), in other embodiments, the network architecture (100) may include fewer components, different components, differently arranged components, or additional functional components than depicted in FIG. 1. Additionally, or alternatively, one or more components of the network architecture (100) may perform functions described as being performed by one or more other components of the network architecture (100).

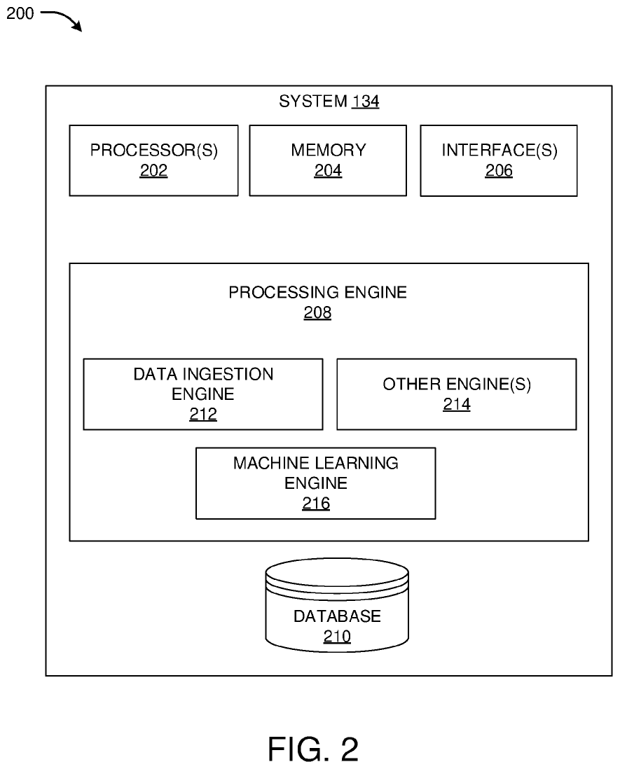

FIG. 2 illustrates an example block diagram (200) of a proposed system (134), in accordance with an embodiment of the present disclosure.

Referring to FIG. 2, the system (134) may comprise one or more processor(s) (202) that may be implemented as one or more microprocessors, microcomputers, microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the system (134). The memory (204) may be configured to store one or more computer-readable instructions or routines in a non-transitory computer readable storage medium, which may be fetched and executed to create or share data packets over a network service. The memory (204) may comprise any non-transitory storage device including, for example, volatile memory such as random-access memory (RAM), or non-volatile memory such as erasable programmable read only memory (EPROM), flash memory, and the like.

In an embodiment, the system (134) may include an interface(s) (206). The interface(s) (206) may comprise a variety of interfaces, for example, interfaces for data input and output (I/O) devices, storage devices, and the like. The interface(s) (206) may also provide a communication pathway for one or more components of the system (134). Examples of such components include, but are not limited to, processing engine(s) (208) and a database (210), where the processing engine(s) (208) may include, but not be limited to, a data ingestion engine (212), other engine(s) (214), and a machine learning engine (216). In an embodiment, the other engine(s) (214) may include, but not limited to, a data management engine, an input/output engine, and a notification engine.

In an embodiment, the processing engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor-executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the system (134) may comprise the machine-readable storage medium storing the instructions and the processing resource to execute the instructions, or the machine-readable storage medium may be separate but accessible to the system (134) and the processing resource. In other examples, the processing engine(s) (208) may be implemented by electronic circuitry.

In an embodiment, the processor (202) may receive data timing information via the data ingestion engine (212). The data timing information may be associated with one or more UEs (108) coupled to the ORAN (104) via a LAF (102), where the LAF (102) may be communicatively coupled to the ORAN (104) and configured to receive the data timing information from an AF (110) configured in a core network (114). The processor (202) may store information in the database (210).

In an embodiment, the processor (202) may determine if uplink synchronization is established between the ORAN (104) and the one or more UEs (108) based on the data timing information. In response to a positive determination, the processor (202) may transmit scheduling information to the one or more UEs (108) from the ORAN (104), where the scheduling information comprises a periodicity associated with allocation of one or more RBs. In response to a negative determination, the processor (202) may restrict the transmission of the scheduling information to the one or more UEs (108).

In an embodiment, the processor (202) may allocate one or more RBs to the one or more UEs (108) based on the scheduling information. The processor (202) may enable data transfer between the ORAN (104) and the one or more UEs (108) based on the allocation of the one or more RBs.

In another embodiment, the processor (202) may, in response to the positive determination, determine, via a machine learning model, a data transmission pattern form the data timing information for a predetermined period and transmit the scheduling information to the one or more UEs (108) based on the data transmission pattern. The machine learning model may be implemented by the machine learning engine (216).

In another embodiment, the one or more UEs (108) may be configured to transmit the data timing information to the AF (110) via an IP.

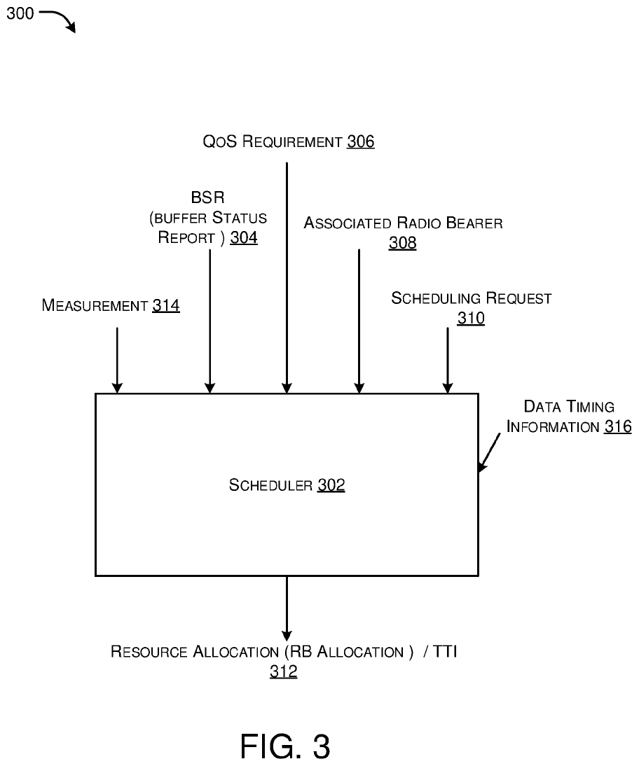

FIG. 3 illustrates an example representation (300) of a scheduling process in an ORAN, in accordance with an embodiment of the present disclosure.

In an embodiment, scheduling may include a process of allocating resources for transmitting data. As in Long-Term Evolution (LTE) (in all cellular communication), new radio (NR) scheduling may be dictated by a network and UE may follow the communication from the network. The scheduling may be dependent on the many factors (including quality of service (QoS)) and not based on an application type. There may be two types of scheduling in the DL direction. One is called dynamic scheduling and the other is called semi-persistent scheduling (SPS). Dynamic scheduling may refer to the mechanism in which each and every physical downlink shared channel (PDSCH) is scheduled by downlink control information (DCI) (DCI 1_0 or DCI 1_1). SPS may refer to the mechanism in which the PDSCH transmission may be scheduled by a radio resource control (RRC) message.

In an embodiment, for the scheduler operation, the UE buffer status (304) and QoS (306) requirements of each UE (108) and associated radio bearers (308) may be taken into account to allocate resources between the one or more UEs (108. The scheduler (302) may also allocate resources based on radio conditions at the UE (108) which are known via measurements made at the gNB (base station) or communicated by the UE (108). Radio resources may be assigned in a unit of slot and the radio resources may be made up of the one or more RBs. The scheduler (302) may receive the associated radio bearers (308), the buffer status (304), the QoS (306) requirements of each UE (108), a measurement (314) based on a scheduling request (310) sent by the UE (108), and data timing information (316). The scheduler (302) may perform resource allocation (312) per a transmission time interval (TTI).

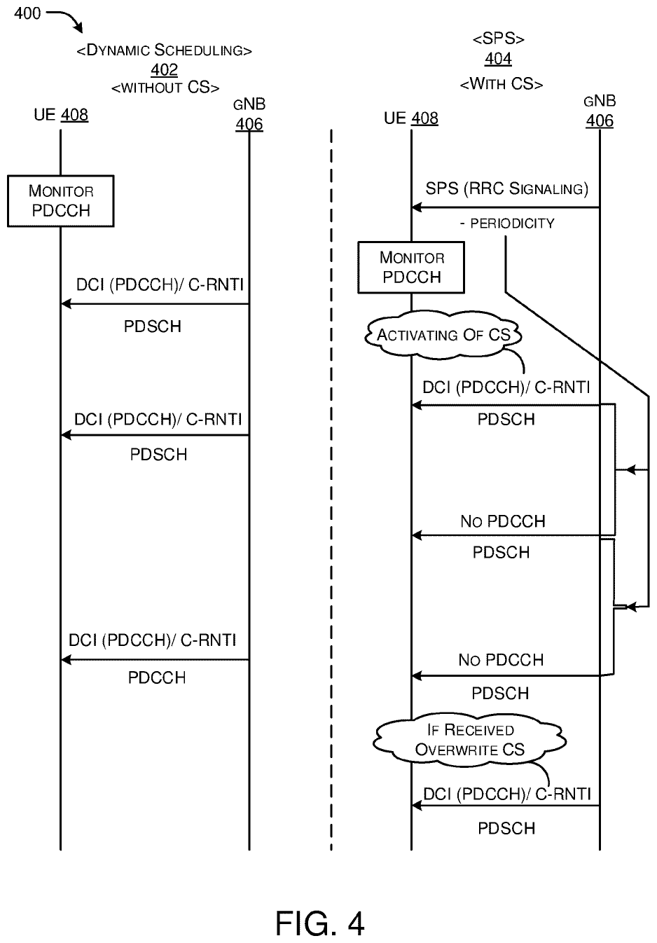

FIG. 4 illustrates an example flow diagram (400) of the scheduling process, in accordance with an embodiment of the present disclosure.

In an embodiment, the 5G wireless technology is meant to deliver higher multi-Giga bytes per second (Gbps) peak data speeds, ultra-low latency, more reliability, massive network capacity, increased availability, and a more uniform user experience to more users. Higher performance and improved efficiency empower new user experiences and connects new industries. The 6G network may be architected to achieve an expansion of human experience across physical, biological, and digital worlds while at the same time enabling next-generation industrial operations environment beyond industry 4.0 in dimensions of performance such as positioning, sensing, ultra-reliability, energy efficiency, and extreme real-time. 6G network may be expected to provide novel radio and access architecture for both communications and sensing purposes. Artificial Intelligence (AI) optimized wide area network and data center co-design, as well as dynamic orchestration of personalized services to revolutionize the long tail of niche consumer interests may be included with 6G. While demand for mobile broadband may continue to increase among consumers and enterprise alike, uptake of ultra-reliable and low latency may be largely driven by specialized and local use cases in conjunction with non-public networks, and often with augmented intelligence.

In an embodiment, as illustrated in FIG. 4, scheduling may include dynamic scheduling (402) and SPS (404). Dynamic scheduling (402) may be the mechanism in which each and every PDSCH may be scheduled by the DCI (DCI 1_0 or DCI 1_1). SPS (404) may be the mechanism in which the PDSCH transmission is scheduled by the RRC message. The SPS (404) may also be called as configured scheduling in 5G. Configured scheduling may be a mechanism in which the gNB (406) may schedule PDSCH/physical uplink shared channel (PUSCH) without using the DCI for every transmission. Further, the gNB (406) may configure all the detailed scheduling parameters in RRC and the gNB/UE (408) may transmit the PDSCH and the PUSCH according to the parameters specified in a RRC message container. This may help the gNB (406) to reduce the load of physical/Media Access Control (PHY/MAC) scheduling. Also, IoT as a use case category may come up with many use cases which involves machine to machine (M2M) communication and machine to human communication. The scale of such devices may also be expected to be massive with that the connection density of such deployment expected to be in the millions of devices per square kilometre (Sq. Km). IoT data may also be timed and predictable in most cases specifically when the data is from sensors, cameras, etc. which may render themselves to certain optimizations in terms of scheduling resources to such IoT devices. To avoid an overhead on the end-to-end system and especially in the RAN, the SPS (404) may be used for data generated by IoT devices.

Further, the SPS (404) may help to reduce the control channel overhead in a wireless network by having radio resources scheduled prior to transmission for certain applications like voice or video calls. Such persistent scheduling may help UEs (408) to use the radio resources especially when there is a need to transfer data packets continuously without waiting for scheduling information at every instance. In scenarios like voice/video calling, there may be a data packet that needs to be sent as per the desired QoS. If dynamic scheduling (402) is used, then the control channels used in the DL may encounter a huge overhead and reduce the overall spectrum efficiency. Furthermore, in IoT/IIOT scenarios, there may be a case where UEs (408) need to send data packets in short bursts, periodic, or aperiodic. In the current scenario, the network may choose dynamic scheduling (402). But, in IoT, with massive scale of deployments, dynamic scheduling (402) may be a big signaling overhead. This may reduce the network/spectrum efficiency to a great extent. One of the ways to improve the spectral efficiency is by reducing the overhead on the radio resources that are used by the control channel information in either of the direction. Most of the resources are also used in sharing the scheduling information in the DL control channels so that UEs (408) know exactly what radio resources (in both time and frequency domain) to use for data transmission. Therefore, sharing control information in either the UL or in the DL direction may reduce the overhead on the control channels using radio resources.

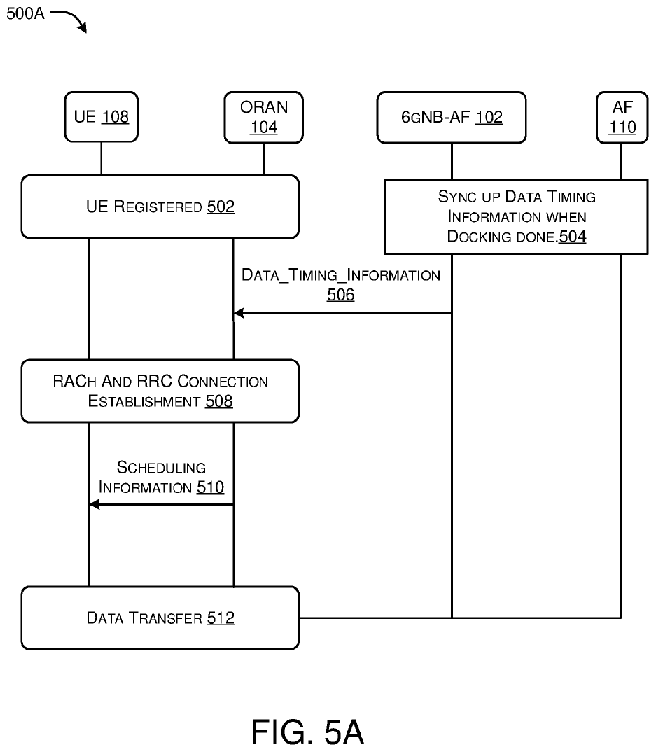

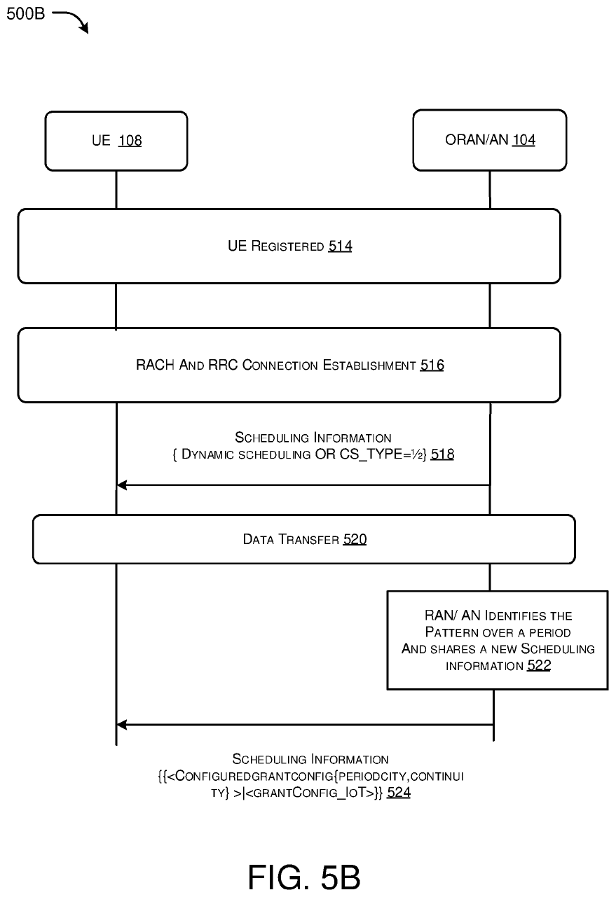

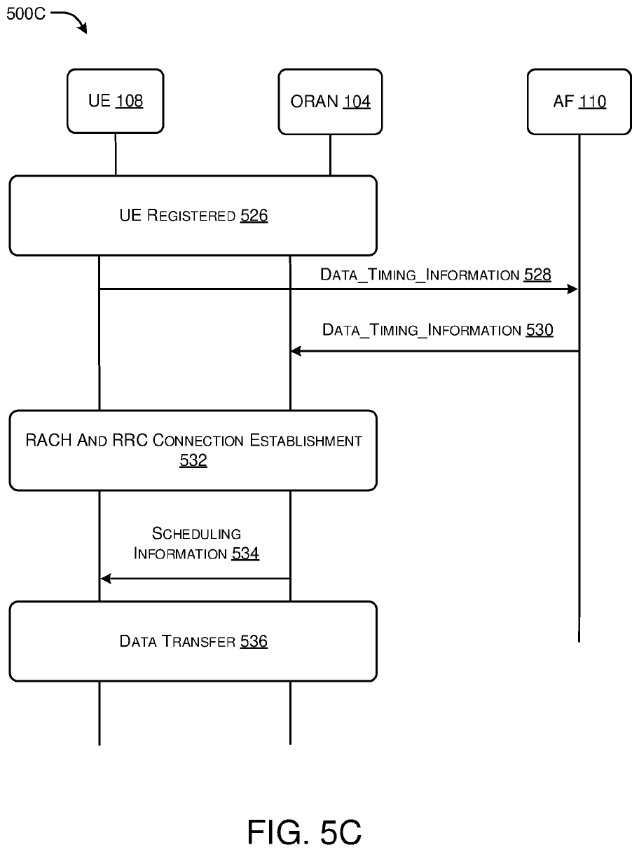

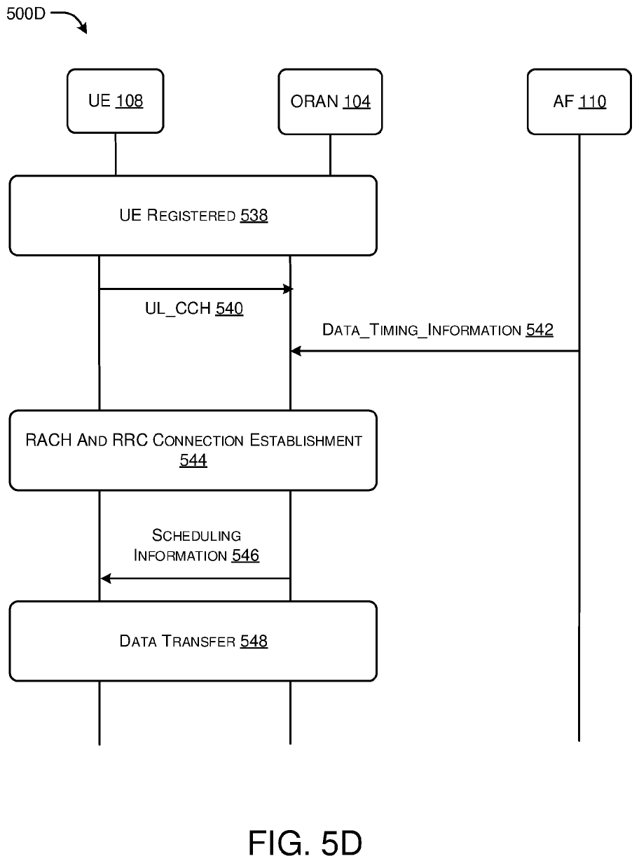

FIGS. 5A-5D illustrate example flow diagrams (500A, 500B, 500C, 500D) of a scheduling process by the proposed system (134), in accordance with embodiments of the present disclosure.

As illustrated in FIG. 5A, the flow diagram (500A) may include the following steps:

At step 502: The UE (108) may be registered with the ORAN (104).

At step 504: The 6gNB LAF (102) may receive data timing information from an AF (110) configured in the core network (114).

At step 506: The 6gNB LAF (102) may transmit the data timing information to the ORAN (104).

At step 508: The system (134) may determine if a random access channel (RACH)/radio resource control (RRC) associated with uplink synchronization of the UE (108) is established.

At step 510: Based on a positive determination, the ORAN (104) may process the data timing information and send scheduling information to the UE (108).

At step 512: The system (134) may enable data transfer between the UE (108) and ORAN (104).

As illustrated in FIG. 5B, the flow diagram (500B) may include the following steps:

At step 514: The UE (108) may be registered with the ORAN (104).

At step 516: The system (134) may determine if a RACH/RRC associated with uplink synchronization of the UE (108) is established.

At step 518: Based on a positive determination, the ORAN (104) may receive data timing information and send scheduling information to the UE (108).

At step 520: The system (134) may enable data transfer between the UE (108) and ORAN (104).

At step 522: The ORAN (104), via a machine learning model, may identify a data transmission pattern from the data timing pattern of the UE (108) and transmit scheduling information to the UE (108).\

At step 524: The ORAN (104) transmits scheduling information to the UE (108).

As illustrated in FIG. 5C, the flow diagram (500C) may include the following steps:

At step 526: The UE (108) may be registered with an ORAN (104).

At step 528: The UE (108) may transmit data timing information to an AF (110) configured in the core network (114) using an IP based communication method.

At step 530: The AF (110) may further transmit the data timing information to the ORAN (104).

At step 532: The system (134) may determine if a RACH/RRC associated with uplink synchronization of the UE (108) is established.

At step 534: Based on a positive determination, the ORAN (104) may process the data timing information and send scheduling information to the UE (108).

At step 536: The system (134) may enable data transfer between the UE (108) and the ORAN (104).

As illustrated in FIG. 5D, the flow diagram (500D) may include the following steps:

At step 538: The UE (108) may be registered with the ORAN (104).

At step 540: The UE (108) may share data timing information with the ORAN (104).

At step 542: An AF (110) configured with a core network (114) may share additional data timing information with the ORAN (104).

At step 544: The system (134) may determine if a RACH/RRC associated with uplink synchronization of the UE (108) is established.

At step 546: Based on a positive determination, the ORAN (104) may process the data timing information and send scheduling information to the UE (108).

At step 548: The system (134) may enable data transfer between the UE (108) and the ORAN (104).

In an embodiment, the RRC or MAC in the UE (108) may share the data timing information like data periodicity, data type to the ORAN (104) directly via UL control channel information.

```
ULCCCH_Message::
{
  RRC_Connection_Request ::
  {
    UE_Identity;
    Establishment_Cause;
    Data_Timing_Infomration;
  }
}
```

The MAC may also provide the same message via a Hybrid Automatic Repeat Request (HARQ). The message may include the following:

```
tdd-UL-DL-ConfigurationCommon {
  referenceSubcarrierSpacing kHz30,
  pattern 1 {
    dl-UL-TransmissionPeriodicity ms5,
    nrofDownlinkSlots 7,
    nrofDownlinkSymbols 2,
    nrofUplinkSlots 2,
  nrofUplinkSymbols 0
  }
Pattern2 {{Application_class== {Periodic, Busty, Continuous, . . . },
                        Periodicity == 1234353 ms,
                        Data_Priority == {High, Medium, Low }}
```

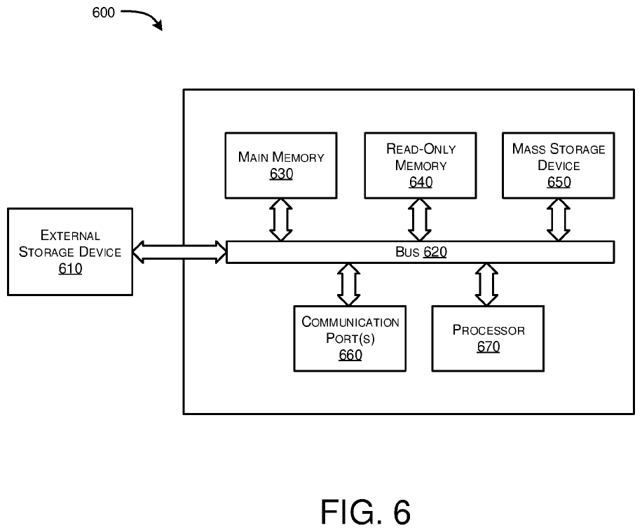

FIG. 6 illustrates an exemplary computer system (600) in which or with which embodiments of the present disclosure may be implemented.

As shown in FIG. 6, the computer system (600) may include an external storage device (610), a bus (620), a main memory (630), a read-only memory (640), a mass storage device (650), a communication port(s) (660), and a processor (670). A person skilled in the art will appreciate that the computer system (600) may include more than one processor and communication ports. The processor (670) may include various modules associated with embodiments of the present disclosure. The communication port(s) (660) may be any of an RS-232 port for use with a modem-based dialup connection, a 10/100 Ethernet port, a Gigabit or 10 Gigabit port using copper or fiber, a serial port, a parallel port, or other existing or future ports. The communication ports(s) (660) may be chosen depending on a network, such as a Local Area Network (LAN), Wide Area Network (WAN), or any network to which the computer system (600) connects.

In an embodiment, the main memory (630) may be Random Access Memory (RAM), or any other dynamic storage device commonly known in the art. The read-only memory (640) may be any static storage device(s) e.g., but not limited to, a Programmable Read Only Memory (PROM) chip for storing static information e.g., start-up or basic input/output system (BIOS) instructions for the processor (670). The mass storage device (650) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus (620) may communicatively couple the processor(s) (670) with the other memory, storage, and communication blocks. The bus (620) may be, e.g. a Peripheral Component Interconnect PCI)/PCI Extended (PCI-X) bus, Small Computer System Interface (SCSI), USB, or the like, for connecting expansion cards, drives, and other subsystems as well as other buses, such a front side bus (FSB), which connects the processor (670) to the computer system (600).

In another embodiment, operator and administrative interfaces, e.g., a display, keyboard, and cursor control device may also be coupled to the bus (620) to support direct operator interaction with the computer system (600). Other operator and administrative interfaces can be provided through network connections connected through the communication port(s) (660). Components described above are meant only to exemplify various possibilities. In no way should the aforementioned exemplary computer system (600) limit the scope of the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

### Advantages of the Invention

The present disclosure provides a system and a method for application specific scheduling in Open Radio Access Network (ORAN) that improves the spectral efficiency by reducing an overhead among the radio resources used by the control channel information in an uplink (UL) and a downlink (DL) direction.

The present disclosure increases the spectrum efficiency and the connection density with an optimized way of scheduling the resources irrespective of a mode of operation.

We claim:

1. A system (134) for application specific scheduling in an Open Radio Access Network (ORAN) (104), the system (134) comprising:
a processor (202) communicatively coupled to the ORAN (104);
a memory (204) operatively coupled with the processor (202), wherein said memory (204) stores instructions which, when executed by the processor (202), cause the processor (202) to:
receive data timing information associated with one or more user equipments (UEs) (108) coupled to the ORAN (104) via a Lightweight Application Function (LAF) (102), wherein the LAF (102) is communicatively coupled to the ORAN (104) and configured to receive the data timing information from an AF (110) configured in a core network (114);
determine if uplink synchronization is established between the ORAN (104) and the one or more UEs (108) based on the data timing information;
in response to a positive determination, transmit scheduling information to the one or more UEs (108), wherein the scheduling information comprises a periodicity associated with allocation of one or more resource blocks (RBs);
allocate the one or more RBs to the one or more UEs (108) based on the scheduling information; and
enable data transfer between the ORAN (104) and the one or more UEs (108) based on the allocated one or more RBs.

2. The system (134) as claimed in claim 1, wherein in response to a negative determination, the processor (202) is to restrict the transmission of the scheduling information to the one or more UEs (108).

3. The system (134) as claimed in claim 1, wherein in response to the positive determination, the processor (202) is to determine, via a machine learning model, a data transmission pattern from the data timing information for a predetermined period, and transmit the scheduling information to the one or more UEs (108) based on the data transmission pattern.

4. The system (134) as claimed in claim 1, wherein the one or more UEs (108) are configured to transmit the data timing information to the AF (110) via an Internet Protocol (IP).

5. A method for application specific scheduling in an Open Radio Access Network (ORAN) (104), the method comprising:
receiving, by a processor (202) associated with a system (134), data timing information associated with one or more user equipments (UEs) (108) coupled to the ORAN (104) via a Lightweight Application Function (LAF) (102), wherein the LAF (102) is configured to receive the data timing information from an AF (110) configured in a core network (114);
determining, by the processor (202), if uplink synchronization is established between the ORAN (104) and the one or more UEs (108) based on the data timing information;
in response to a positive determination, transmitting, by the processor (202), scheduling information to the one or more UEs (108), wherein the scheduling information comprises a periodicity associated with allocation of one or more resource blocks (RBs);
allocating, by the processor (202), the one or more RBs to the one or more UEs (108) based on the scheduling information; and
enabling, by the processor (202), data transfer between the ORAN (104) and the one or more UEs (108) based on the allocated one or more RBs.

6. The method as claimed in claim 5, wherein in response to a negative determination, the method comprises restricting, by the processor (202), the transmission of the scheduling information to the one or more UEs (108).

7. The method as claimed in claim 5, comprising determining, by the processor (202), in response to the positive determination, via a machine learning model, a data transmission pattern from the data timing information for a predetermined period, and transmitting, by the processor (202), the scheduling information to the one or more UEs (108) based on the data transmission pattern.

8. The method as claimed in claim 5, comprising transmitting, by the one or more UEs (108), the data timing information to the AF (110) via an Internet Protocol (IP).

9. A user equipment (UE) (108) for sending requests, the UE (108) comprising:
one or more processors communicatively coupled to a processor (202) associated with a system (134) and configured with an Open Radio Access Network (ORAN) (104), wherein the one or more processors are coupled with a memory, and wherein said memory stores instructions which, when executed by the one or more processors, cause the one or more processors to:
transmit data timing information to an Application Function (AF) (110) in a core network (114), wherein the processor (202) is configured to:
receive the data timing information from the UE (108) via a Lightweight Application Function (LAF) (102);
determine if uplink synchronization is established between the ORAN (104) and the UE (108) based on the data timing information;
in response to a positive determination, transmit scheduling information to the UE (108), wherein the scheduling information comprises a periodicity associated with allocation of one or more resource blocks (RBs);
allocate the one or more RBs to the UE (108) based on the scheduling information; and
enable data transfer between the ORAN (104) and the UE (108) based on the allocated one or more RBs.

10. A non-transitory computer readable medium comprising a processor with executable instructions, causing the processor to:
receive data timing information associated with one or more user equipments (UEs) (108) coupled to an Open Radio Access Network (ORAN) (104) via a Lightweight Application Function (LAF) (104), wherein the LAF (104) is communicatively coupled to the ORAN (104) and configured to receive the data timing information from an AF (110) configured in a core network (114);
determine if uplink synchronization is established between the ORAN (104) and the one or more UEs (108) based on the data timing information;
in response to a positive determination, transmit scheduling information to the one or more UEs (108), wherein the scheduling information comprises a periodicity associated with allocation of one or more resource blocks (RBs);
allocate the one or more RBs to the one or more UEs (108) based on the scheduling information; and
enable data transfer between the ORAN (104) and the one or more UEs (108) based on the allocated one or more RBs.
